(19) United States
(12) Patent Application Publication
(10) Pub. No.: US 2026/0099823 A1
(43) Pub. Date: Apr. 9, 2026

(54) SYSTEMS FOR PREDICTIVE VEHICLE MAINTENANCE AND VEHICLE COMPONENT MANAGEMENT

(71) Applicant: FCA US LLC, Auburn Hills, MI (US)

(72) Inventors: Rajeev K Tiwari, Auburn Hills, MI (US); Emily A Robb, Auburn Hills, MI (US); Adinath Jagannath Jadhav, Pune (IN); Daniel P Cashen, Auburn Hills, MI (US)

(21) Appl. No.: 18/909,058

(22) Filed: Oct. 8, 2024

(51) Int. Cl. G06Q 10/20; G07C 5/00; G07C 5/08

(52) U.S. Cl. CPC G06Q 10/20; G07C 5/006; G07C 5/008; G07C 5/0808

(57) ABSTRACT

A method for determining a vehicle maintenance schedule and communicating with a vehicle user, includes determining at a backend portion a base maintenance schedule for one or more vehicle components of multiple vehicles based at least in part on background vehicle data and receiving, from a frontend portion of multiple vehicles, vehicle use data for the multiple vehicles including a first vehicle. In the method, an adjusted maintenance schedule is determined for the first vehicle based at least in part on the vehicle use data for the first vehicle, a notification is provided from the backend portion to the first vehicle in accordance with the adjusted maintenance schedule and information regarding the adjusted maintenance schedule is provided to at least one service center. This allows both the person who uses the vehicle and a service center to make preparations for any potential repairs or maintenance that may be required, as outlined in the adjusted maintenance schedule.

### FIELD

The present disclosure relates to systems for predictive vehicle maintenance and vehicle component management.

### BACKGROUND

Diagnosing and managing vehicle malfunctions is increasingly challenging as vehicles increasingly become more sophisticated. Existing diagnostic systems often utilize only an initial maintenance schedule determined before the vehicle is sold, which fails to identify components that need early service and those that can last longer than initially determined. Further, systems lack proactive or predictive features that enable individualized maintenance programs for each vehicle based on how the vehicle is used, data from similar vehicles as well as information from each vehicle, among other things. Additionally, a lack of efficient and connected vehicle repair management system contributes to inefficiencies in coordinating repairs between vehicle owners, service centers, and technicians. There is a growing demand for integrated systems that not only diagnose vehicle issues but also enhance the overall vehicle use and repair experience.

### SUMMARY

In at least some implementations, a method for determining a vehicle maintenance schedule and communicating with a vehicle user includes determining at a backend portion a base maintenance schedule for one or more vehicle components of multiple vehicles based at least in part on background vehicle data, receiving, from a frontend portion of multiple vehicles, vehicle use data for the multiple vehicles including a first vehicle, determining an adjusted maintenance schedule for the first vehicle based at least in part on the vehicle use data for the first vehicle, providing a notification from the backend portion to the first vehicle in accordance with the adjusted maintenance schedule, and making information related to the adjusted maintenance schedule available to at least one vehicle service center.

In at least some implementations, the step of determining an adjusted maintenance schedule is done as a function of a vehicle simulation performed at the backend portion. In at least some implementations, the vehicle simulation is conducted with a digital twin of the vehicle, and wherein the digital twin is updated with vehicle use data from the first vehicle and from the multiple vehicles. In at least some implementations, the vehicle simulation is performed based in part on vehicle use data from the first vehicle provided to the backend portion over time. In at least some implementations, the vehicle simulation is performed based in part on vehicle use data from the multiple vehicles provided to the backend portion over time.

In at least some implementations, the background vehicle data includes one or more of a predetermined maintenance schedule provided by a vehicle manufacturer, a vehicle type and a vehicle age, and wherein the adjusted maintenance schedule is determined based at least in part on the predetermined maintenance schedule, the vehicle type and the vehicle age of the first vehicle, and based at least in part on the vehicle use data for the multiple vehicles other than the first vehicle.

In at least some implementations, the adjusted maintenance schedule is based at least in part on diagnostic data from one or both of an onboard vehicle diagnostic system of the frontend portion and a remote vehicle diagnostic system of the backend portion.

In at least some implementations, the information related to the adjusted maintenance schedule includes information regarding a part and a service that will be needed by the first vehicle within a threshold amount of time.

In at least some implementations, the adjusted maintenance schedule provides a priority level or rating for a service needed by the first vehicle, wherein the steps of providing the notification and making the information related to the adjusted maintenance schedule available to at least one vehicle service center are done within a time period established based at least in part on the priority level or rating. In at least some implementations, the time period is shorter for repairs that affect: a) the vehicle safety, or b) the ability to operate the vehicle after the repair becomes needed, than for c) repairs not related to safety and for which the vehicle can continue to operate after the repair becomes needed.

In at least some implementations, a system used to determine a vehicle maintenance schedule and communicate with a vehicle user, includes one or more vehicle sensors, a control system that includes a data storage unit and an electronic control unit, where the control system is in communication with the one or more vehicle sensors, a communications unit and a backend portion. The communications unit is communicated with the control system and that has a receiver by which information is received at a network vehicle and a transmitter by which information is transmitted from the network vehicle. The backend portion is part of a cloud-based system, and the backend portion includes a processor and memory with programming to:
determine at a backend portion a base maintenance schedule for one or more vehicle components of multiple vehicles based at least in part on background vehicle data;
receive, from a frontend portion of multiple vehicles, vehicle use data for the multiple vehicles including a first vehicle;
determine an adjusted maintenance schedule for the first vehicle based at least in part on the vehicle use data for the first vehicle;
provide a notification from the backend portion to the first vehicle in accordance with the adjusted maintenance schedule; and
make information regarding the adjusted maintenance schedule available to at least one service center.

In at least some implementations, the vehicle use data includes data from one or more vehicle sensors.

In at least some implementations, the background vehicle data includes a predetermined maintenance schedule provided by a vehicle manufacturer.

In at least some implementations, the background vehicle data includes one or more of a vehicle type and a vehicle age, and wherein the adjusted maintenance schedule is determined based at least in part on the vehicle type of the first vehicle and the vehicle age of the first vehicle, and based at least in part on the vehicle use data for the multiple vehicles other than the first vehicle.

In at least some implementations, the adjusted maintenance schedule is based at least in part on diagnostic data from one or both of an onboard vehicle diagnostic system of the frontend portion and a remote vehicle diagnostic system of the backend portion. In at least some implementations, the frontend portion generates diagnostic codes during use of the vehicle, and wherein the adjusted maintenance schedule is based at least in part on the diagnostic codes.

In at least some implementations, the backend portion includes programming that provides a digital twin of the first vehicle and wherein the adjusted maintenance schedule is based at least in part on predicted future use of the first vehicle that is performed with the digital twin. In at least some implementations, determining an adjusted maintenance schedule is done as a function of a vehicle simulation performed at the backend portion. In at least some implementations, the vehicle simulation is performed based in part on vehicle use data from the first vehicle provided to the backend portion over time. In at least some implementations, the vehicle simulation is performed based in part on vehicle use data from the multiple vehicles provided to the backend portion over time.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a system for determining customized recommendations for a vehicle user;

FIG. 2 is a diagrammatic view of a vehicle that defines part of the system;

FIG. 3 is a diagrammatic view of a vehicle control system which may define part of a frontend portion of the system;

FIG. 4 is a diagrammatic view of information sources and programs of the system;

FIG. 5 is a flowchart of a method for managing notifications to a vehicle user; and

FIG. 6 is a graph of a repair cost analysis.

### DETAILED DESCRIPTION

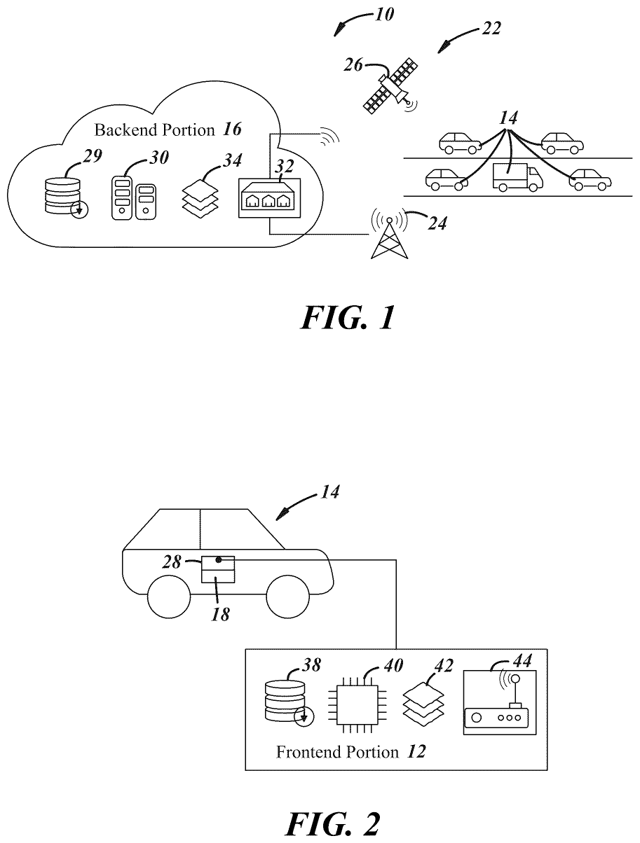

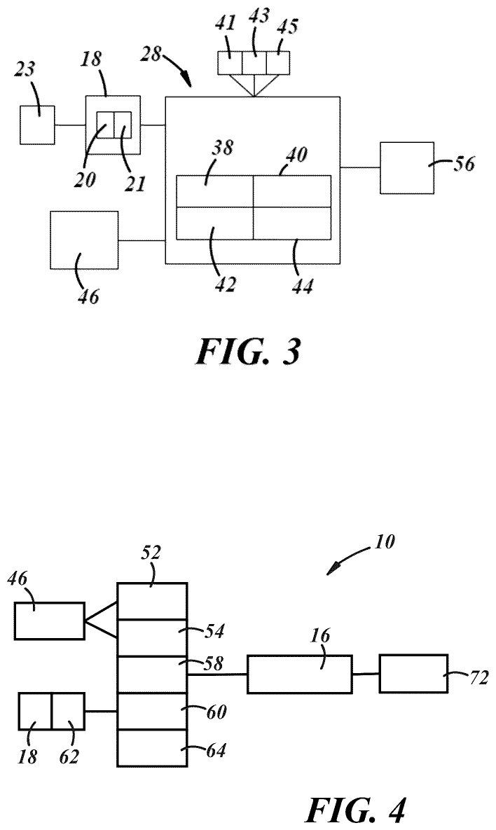

Referring in more detail to the drawings, FIG. 1 illustrates a vehicle information system 10 including a frontend portion 12 with one or more network vehicles 14 that are in communication with a backend portion 16 via one or more communication devices and suitable communication protocols. The network vehicles include in-vehicle infotainment (IVI) systems 18 (FIGS. 2 and 3) that utilize a combination of software and hardware components to provide a wide range of information, system controls and entertainment. As diagrammatically shown in FIG. 3, the IVI system 18 may include one or more display screens 20 and a user interface 21. As described herein, the information system 10 utilizes a wide range of data and parameters to manage maintenance, repair and performance of a vehicle, to communicate with a user 23 (FIG. 3) of the vehicle, and to communication with entities associated with the vehicle such as the vehicle manufacturer and repair facilities.

With reference to the schematic block diagrams in FIGS. 1 and 2, the vehicle information system 10 may be a cloud-based system that may receive incoming information from individual ones of the network vehicles 14 and send outgoing information to multiple network vehicles 14, where the outgoing information may include mass communications (i.e. notifications) that are the same for multiple vehicles or individual communications that are each specific to the vehicle to which each individual communication is sent. The system 10 may gather real-time information from network vehicles 14, may gather information at determined intervals or times, and the system 10 may analyze the information and determine if a notification should be sent to one or more vehicles or a vehicle-related entity, as noted in more detail later.

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions). Further, information may be sent from or a vehicle as during use of the vehicle, or before or after use of the vehicle.

System 10 may deliver hosted services via the internet and/or other communication networks and may be structured as a public, private or hybrid cloud, for example. According to one non-limiting example, vehicle information system 10 is structured as a private cloud and generally includes the backend portion 16 and the frontend portion 12 that is distributed across a fleet of network vehicles 14, where each network vehicle 14 is capable of obtaining and providing information as well as communicating with the backend portion 16 over a secure communications network 22 (e.g., secure vehicle-to-cloud (V2C) network). The secure communications network 22 may include a cellular-based network 24, a satellite-based network 26, a city-wide WiFi-based network, some other type of communications network and/or a combination thereof. Although only a few network vehicles 14 are shown in the drawings, it should be appreciated that system 10 may interact with a large fleet of vehicles that can include dozens, hundreds, thousands or even more vehicles. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the data/information used to formulate notifications and information for vehicles may be analyzed by control systems 28 and processors on-board a network vehicle 14 or by the backend portion 16 or both, as desired. The backend portion 16 may be managed or controlled by the vehicle manufacturer and can be part of a larger cloud-based system that the vehicle manufacturer uses to communicate and interact with a large fleet of vehicles for a multitude of purposes. For example, the backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including memory/data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion and receiving notifications, programs, instructions and the like from the backend portion 16. Depending on the particular arrangement, the frontend portion 12 may also be responsible for gathering camera, sensor, location and/or other data from devices on the vehicle 14, including diagnostic and vehicle use data, and sending such information to the backend portion 16. The frontend portion 12 is typically responsible for running the applications that interface with the users in the different vehicles 14, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and may include any suitable combination of software and/or hardware resources including, but not limited to, components, devices, computers, modules and/or systems (each of these resources is referred to herein as a “frontend resource,” which broadly includes any such resource located at the frontend portion 12).

In one example, the frontend portion 12 has a number of frontend resources including a vehicle control system 28 having one or more vehicle electronic module(s) installed in vehicles 14, which may include some combination of a data storage unit 38, an electronic control unit and/or processor(s) 40, applications 42, a communications unit 44 (e.g., one that includes a telematics unit and/or other communication devices with a receiver by which information is received at unit 44 and a transmitter by which information is sent from the unit 44), as well as other suitable frontend resources. The control system 28 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

In order to perform the functions and desired processing set forth herein, as well as the computations therefore, the control system 28 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the control system 28 may include input signal processing and filtering to enable accurate sampling and conversion or acquisitions of such signals from communications interfaces and sensors. As used herein the terms control system 28 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 28 may be distributed among different vehicle modules, such as an infotainment system control module, engine control module or unit, powertrain control module, transmission control module, and the like, if desired, and the memory and one or more processors may be one or both integrated into the vehicle 14 or remotely located and wirelessly communicated to the vehicle 14, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

To control various functions of the vehicle 14, the vehicle control system 28, among other things, monitors and provides controls for operation of various vehicle systems. For example, the vehicle 14 may include drive by wire, brake by wire and steer by wire systems, or the drive, brake and steering systems may be mechanically linked, as desired, and the control system 28 may be programmed or include instructions to respond to driver action, such as movement of the throttle, and brake and steering inputs. The magnitude of the power output from the powertrain system and brake system varies as a function of the driver operation of the throttle and brake inputs 41, 43, as well as the instructions executed by the control system 28, which may vary in different circumstances and may be implemented in view of variables and by way of look-up tables, maps, algorithms and the like. Additionally, the magnitude of lateral accelerations may vary as a function of driver actuation of a steering input 45. And these systems may be operated partially or fully-autonomously, as desired.

To enable control and monitoring of various vehicle operating, environmental and other conditions related to vehicle operation, the control system 28 may include or be communicated with a range of sensors 46, shown diagrammatically in FIG. 3. By way of some examples, the vehicle 14 may include: a speed sensor that provides an indication of vehicle speed; one or more accelerometers responsive to vehicle accelerations in various directions and orientations; wheel speed sensors responsive to the rotational speed of the vehicle wheels; drive input sensors that sense the position and/or rate of movement of the throttle, brake and/or steering inputs; position or location sensors or devices (such as GPS or the like) to determine the location of the vehicle; temperature sensors for various things like ambient temperature, engine/motor temperature, and the like; fuel level sensor; battery sensor (voltage, charge level, or the like); an odometer; tire pressure sensors and other sensors that may be responsive to or useful in controlling vehicle operation (e.g. current draw of motors, torque sensors, steering sensors, etc). The vehicle may include object detection sensors like cameras, radar, lidar and other sensors, and these sensors may provide information about the vehicle and the surrounding environment. These sensors and data sources may provide dynamic vehicle data 52 or operating parameters and environmental information 54, shown as some of the information types in FIG. 4.

Further, the sensors 46 and the control system 28 may enable diagnostic programs and systems via which the health of vehicle components and systems can be determined, or by which alerts can be provided. The alerts may relate to require maintenance which may be routine/scheduled maintenance or for repair or calibration of a sensor or component, or an indication of a malfunction of a sensor, component or system of the vehicle. In this way, the vehicle may include one or more “On Board Diagnostic (OBD)” components or systems. The components or systems may provide output(s) that are indicative of the operation or health of various components and systems. The outputs may be information, such as codes that represent various information, that is stored in memory of one or both of the frontend portion and the backend portion. The information/codes may be in digital form to be read/interpreted by a suitable device which may include a controller/processor/computer. The OBD systems are not limited to systems, programs or devices that produce output codes for repair or maintenance and many include, for example, programs and control systems that monitor performance of a device or system, and may include routine, predetermined, maintenance programs for various vehicle components and systems.

Additional information about vehicle use, including some dynamic vehicle data, can be obtained via various navigation programs 56 (FIG. 3) that, among other things, compute a travel path to a destination, and convey information about the travel path to a driver in the form of visual and/or audible instructions for navigating the vehicle 14 along the travel path. The navigation programs can use information from the vehicle location sensor (e.g. GPS), a remote device location sensor (e.g. GPS chip of a smartphone in the vehicle) and map data and information relating to road conditions, speed limits, location of intersections and traffic signals, and the level of traffic (such as is available from Waze, GoogleMaps, TomTom maps and other applications and sources). This information can be used to define travel paths that are shortest in total distance or time, or that avoid certain road types (e.g. not paved, toll roads, etc) or areas where travel time is less certain, for example, construction zones. The navigation programs 56 may be integrated into the vehicle control system 28 or infotainment system (which may be considered part of the control system), and/or can be resident on a remote or mobile device 62 that is connected to the vehicle 14 by wired or wireless connection.

Additional vehicle related data may include, by way of non-limiting examples, information about age and type of vehicle which may include information related to the size, weight and performance characteristics of the vehicle such acceleration, braking, steering, and suspension characteristics. Diagnostics data, repair history data, recall information, warranty information, preferred or recommended maintenance schedules and information, and other information may also be provided for each vehicle. This may be called background vehicle data 58 (FIG. 4) and with the dynamic vehicle data 52 may more generally be called vehicle data or vehicle use data.

User data 60 may also be included in the information system 10. This information may include, by way of non-limiting examples, information about the owner or driver, including residence information, historical driving data, travel patterns like frequency of vehicle use, frequently visited locations, vehicle use by times of day and time of year, infotainment system usage, vehicle systems preferences and settings selected by the user, information about subscription services selected by the user, dealership or service center preference(s), and the like.

Further, user data 60 may include preferences of the user that may be input into the system 10 by the user, for example via an internet interface on the remote device 62 (e.g. phone, tablet, computer), or learned by the information system based upon user interaction with the vehicle and IVI system 18 over time, as noted later. The preferences can relate to, by way of non-limiting examples, fuel brands, vehicle service centers, car accessory brands or type, and other information. User data 60 may also include interaction information such as prior sales or purchase information, call center interactions, social media activity and other information.

Still further, user data may include preferences and settings regarding notifications that the user would like to receive or not, for example, with regard to vehicle maintenance suggestions and recommendations. These preferences and settings enable a user to determine, for each program or app, which may include vehicle system programs (e.g. notifications regarding fuel level, tire pressures, etc) and apps added to the vehicle or remote device by the user (generally referred to as apps hereafter), specific conditions for when and how notifications should be sent to the user. A user might choose to have no notifications delivered from one or more apps, or to receive notifications only when the vehicle is not moving, or when the vehicle is moving below a threshold speed, or when the vehicle is on a certain type of road (and not other types of roads, for example), or only after the vehicle is stopped and placed into a park mode, or based on time of day, or to provide audio notifications or other hands-free operations, and so on.

Next, external data 64 may be provided to and used in the analysis by the information system 10. External data 64 may include, by way of non-limiting examples, insurance information, data from similar vehicles, data from third parties (e.g. service centers), information about the terrain and environment, map data including information about the geography, businesses, road and the like, traffic information, status of orders or deliveries requested by the user, and the like.

In use, a wide range of notifications and communications may be provided to a vehicle and the occupants of the vehicle. The notifications may relate to, by way of non-limiting examples, vehicle systems and repair or maintenance or operation thereof (e.g. fuel level alerts, low battery alerts, engine/oil/battery temperature alerts, tire pressures, and other warnings or vehicle indicators, application notifications specific to individual applications accessed through the control system (e.g. the IVI system) or a device paired to the vehicle IVI or control system, and a navigation system or program (e.g. for traffic, accident, construction or road conditions, and route instructions),.

The system may include both an on-board diagnostic system that is part of the frontend portion and an off-board or remote diagnostic system that is part of the backend portion. In addition to predetermined maintenance schedules, the system can, among other things, receive and analyze data to provide predictive and preventative maintenance information. The predictive maintenance information can be generated based on predetermined information (e.g. known parameters and performance indicators for components and systems) as well as predictive programs that are updated and improved based upon information from a particular vehicle as well as from other vehicles.

In at least some implementations, the off-board or remote diagnostic system may include a simulation of the vehicle, sometimes called a “digital twin”. The simulation of the vehicle can be updated by vehicle use data provided from the frontend portion to the backend portion. The simulation of the vehicle and components and systems in the vehicle, can then be used to predict future performance of the vehicle, vehicle systems and components. The simulation of the vehicle can also be updated with vehicle use data from other, similar vehicles to improve the accuracy of future predictions.

Further, the vehicle simulation can give near-term information like an improved estimate of the vehicle range based on the vehicle performance as determined from prior use data and an intended path of travel. This vehicle range estimate can then be used to alert the driver and/or to recommend where refueling or recharging stations that are reachable by the vehicle, with the current fuel/energy available in the vehicle, can be found. As another example, information about a range over which tires at an incorrect air pressure can be driven can be determined from the vehicle use data and communicated to a driver of an affected vehicle as a short-term information item. Similar range or time type notifications for repairs or service items that are needed or recommended can be provided by the system to give users more information about the urgency and issues that can be created by failing to have the repair or service completed. Longer-term information, that is not relevant during the current vehicle trip or use, can be provided to the user when convenient for the user, or according to the user preferences for notifications. For example, a monthly vehicle status report can be provided and components not functioning correctly or that might need repair or replacement in a certain period of time, can be noted in the status report.

The predictive maintenance information and the base maintenance information may be communicated to entities to which the information may be useful. For example, service centers in the area of the vehicle (e.g. near the vehicle owner's residence) or selected by the vehicle owner, for example, can be alerted that a certain part or parts may soon be needed by the vehicle, and the service center can then order and have available the needed parts to ensure that a needed vehicle repair can be done without undue delay such as may be caused by the need to order parts after the parts are needed. With a fleet of vehicles, the age of vehicles and their components, and the individual use data for each vehicle, can be used to predict the general timeframe in which new components will be needed. Service centers can use this information to manage their component inventories to ensure an adequate supply of such components without an oversupply that takes space and costs money to store. Vehicle and component manufacturers can also use this data to ensure an adequate supply of needed components, to determine if components are performing as intended, to decide if improvements to the components are needed, and other considerations.

One simple example is a door switch that provides a signal when the corresponding vehicle door is opened or closed. The door switch may have a predetermined life, for example a number of door opening/closing and switch activation cycles, provided by the vehicle or switch manufacturer. A fleet of vehicles having the door switch can provide data and if the actual, in-service life of the switch is different than the predetermined life, the maintenance schedule for the switch can be adjusted. When a door switch in a vehicle is nearing the number of cycles determined to be near the end of life for the switch, the driver and/or a service center and/or the switch manufacturer can be notified to ensure that a replacement switch is ready or will be available when needed, or the switch can be proactively replaced prior to failing, to reduce down-time and improve customer satisfaction.

One or both of the onboard diagnostics system and the remote diagnostic system may use one or more machine learning algorithms and may include linear regression models to map sensor data to specific vehicle parameters (e.g., engine health, fuel efficiency, emissions content/data).

From the information and vehicle data, the system may include a base repair or maintenance schedule that may include base lifespan information for various components and systems. Examples include predetermined life spans for wear items, such as but not limited to, oil and other fluids, filters, spark plugs, switches, batteries, alternators, tires and brake pads. At or near the end of the life span for wear items, the things must be changed/replaced. While the predetermined life spans may provide a reasonable approximation for the life spans, some vehicles may be driven more aggressively than others, in different environmental conditions (weather, road types, and the like) and the actual life span of wear items will vary across a fleet of vehicles.

By collecting and analyzing data across a fleet of vehicles, repair facilities, users and from the vehicle manufacturer, by way of non-limiting examples, conditions and use parameters that affect life span of wear items may be determined. Then, this information can be compared to the actual information for a specific vehicle and a predictive life span for the wear items can be determined, and an adjusted maintenance schedule can be determined for one or more features, components or systems of the vehicle. This provides a customized system that can improve the accuracy of the maintenance recommendations and potentially improve the vehicle performance and limit damage to other systems (e.g. the engine, brake rotors, transmission, etc).

Beyond the example of wear items, the system may use a wide range of information to predict maintenance of vehicle features, components and systems that are not wear items, and provide an adjusted maintenance schedule, recommendations and notifications for such features, components and vehicle systems. For example, a vehicle may benefit from periodic realignment of its wheels/suspension components, or from an engine or motor tune-up, cleaning of certain items and the like. Such things may have a predetermined or base maintenance schedule and a predicted or adjusted maintenance schedule that may revise the base maintenance schedule based on, for example, specific vehicle use, other vehicle use, repairs done on the specific vehicle and similar vehicles (e.g. with one or more similar components), updated information from the vehicle manufacturer, information from repair facilities and the like. The adjusted maintenance schedule may recommend repairs before or after the base maintenance schedule. Earlier recommendations for repairs can be made to avoid damage or wear of other items and thus, can save the user long term costs and avoid unnecessary repairs. Later recommendations can increase the value that the user gets out of the vehicle's components.

In addition to the predictive maintenance schedule adjustments, the system may also use existing vehicle error or diagnostic codes to recommend vehicle maintenance. The system may correlate one or more codes with one or more repairs or maintenance procedures, across a fleet of vehicles. With the information noted herein the system can use the diagnostic systems and codes to adjust the maintenance schedules or recommend repairs or maintenance that is not part of a predetermined or adjusted schedule, and this recommendation may be for preventative maintenance before a problem exists that requires the vehicle to be serviced. This can reduce vehicle downtime, minimize repair costs, and enhance overall vehicle reliability, factors that can be important to users and in their decision on which vehicle to use.

Further, the system may include an application, such as a web app or internet interface program for repair management, scheduling and repair progress tracking. The program may provide updated inventories and service wait times, for example, to a user to enable a user to pick a service center best able to support the vehicle repair needed. In addition to service recommendations, scheduling and management, the system may provide information to a user about the service that is needed. This information can include components that need to be repaired or replaced, perhaps a typical cost in the geographic area of the vehicle, and optionally, how a user can make the repair or perform the replacement, and the parts, tools, time and skills needed to do so.

Information from the system can be provided to a user in any desired way, such as via the IVI system, or via an application or webpage/portal. In this regard, and for the system in general, user interaction can occur via a remote device (e.g. phone, tablet, computer and via an internet interface) or the IVI system 18, and in particular, a head-unit or main console thereof which may include one or more display screens 20 and the user interface 21. The user interface 21 may include one or more inputs that may be provided in one or more forms, such as but not limited to, touch responsive portions of a display, one or more manually actuated inputs (e.g. dials, buttons or switches), and/or audio inputs including a microphone via which verbal inputs can be given by a user.

The IVI system 18 may display various items and options that may be selected by a user. By way of some non-limiting examples, the items and options may include menu options of vehicle settings and preference menus (for control of heating and cooling options, audio video settings and preferences, door lock functionality, performance settings (sport, eco, etc) and various other settings), program icons displayed for included or embedded apps that may be selected by a user and run by the system, such as via a web portal or application programming interface (API). As noted herein, the system may include programs or “apps” or “web widgets” that may relate to a wide range of tasks and features, such as but not limited to, navigation, audio/video, social media, interaction with paired devices, text messaging, phone use, shopping, restaurants, reviews (e.g. Yelp), and an app store via which apps may be downloaded or updated.

The system provides a unique and comprehensive solution with integrated frontend and backend systems that provide a unified and comprehensive view of the health and performance of a vehicle and various vehicle components and systems. The system facilitates providing users with relevant information and alerts tailored to their specific vehicle, their driving habits and their preferences. The integrated frontend and backend systems also enable advanced predictive maintenance processes to be employed and continually improved and updated for a fleet of vehicles. The system may communicate with a user seamlessly and conveniently via the IVI system, or a web/app-based interface, as desired. Real-time updates, predictive maintenance alerts, and personalized recommendations are seamlessly displayed, offering users an engaging and informed experience. And the system can be continually updated and improved with artificial intelligence/machine learning programs to which is provided a wide range of data from a fleet of vehicles and a wide range of users, enable a comprehensive solution.

In use of the vehicle, the control system 28 may provide information to the backend portion 16 and receive information from the backend portion 16. Some of the information received from the backend portion 16 may include notifications 72 or other messages to be displayed to a user via the IVI system 18, or a paired device. The notifications 72 may be generated as noted herein, including as a function of real-time or current user and vehicle context features, including real-time or near-term vehicle operating parameters.

In at least some implementations, the vehicles 14 may transmit data/information during operation, at certain intervals or in a stream that may occur continuously during vehicle operation and not just upon occurrence of an initiating event that causes the control system 28 to initiate a transmission. Thus, the vehicles 14/control systems 28 can be programmed to transmit data in the ordinary course of vehicle use and regarding numerous vehicle operating parameters. The data can be captured or logged by the backend portion 16 and some analysis conducted. When the status of different vehicle features or systems changes (e.g. on/off or activated/deactivated or activated and adjusted), the data provided from the vehicle 14 may include the numerous vehicle operating parameters and also data indicative of the feature or system status change. The backend portion 16 may then determine occurrence of the feature or system status change and execute methods or programs in accordance with predetermined programs or instructions. The data may be transmitted in any desired format, and for efficiency of computational resources, may be provided in a binary code stream from the vehicle 14 to the backend portion 16, and the backend portion 16 may include programming to decipher/interpret the binary code.

When one or more conditions are met, the backend portion 16 may communicate information, which may include one or more notifications 72, to one or more vehicles 14 for which the notifications are determined to be relevant. In at least some implementations, the frontend system may also be capable of providing notifications to a user based on output from programs of the frontend portion without requiring communication of the notification from the backend portion. The notifications can be provided to the vehicle 14 for presentation to or review by a vehicle occupant in any desired way. The notice can be provided on a vehicle display 20, such as in a pop-up window including text, graphic(s), animation(s), etc., in an audio file played by the vehicle infotainment system 18, or provided to a remote device that is paired or otherwise connected to the vehicle control system 28 for audible or visual presentation, or by some combination of these non-limiting examples.

The simulated vehicle model(s) and algorithms may be trained with initial data sets and updated continuously or as desired, as additional information is provided in the system and as feedback about past maintenance or service alerts, repairs or other interactions, and management thereof are factored into the models to improve the relevance and accuracy of future such events. In this way, the system can provide predetermined and predictive maintenance or service alerts each user of the system based at least in part on specific vehicle use, use of other vehicles (e.g. similar vehicles), information from maintenance facilities, the vehicle manufacturer including predetermined maintenance schedules and predetermined component life spans, user specific preferences or settings and current/real-time data. The analyses and data and model refinement may be done by the backend portion, data transmission to and from the backend portion may be done seamlessly to the users, and the notifications can be provided in a convenient way via the IVI system 18, and, in at least some implementations, with an integrated web interface of the IVI system 18 that enables a wide range of options and features for users.

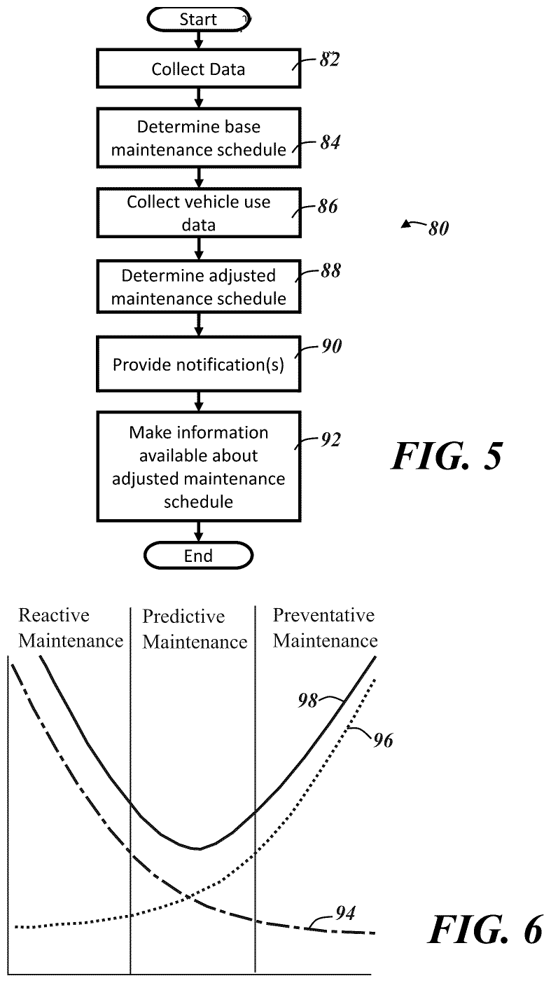

In at least some implementations, as generally shown in FIG. 5, a method 80 for determining a maintenance schedule for one or more features, components or systems of a vehicle, and for communicating maintenance information (e.g. notifications) to a user and at least one service center, includes: in step 82, collecting data, which includes, for example, vehicle data, user data, and external data. In step 84, at the backend portion, a base maintenance schedule may be determined for one or more vehicle components of multiple vehicles based at least in part on background vehicle data. Next, in step 86, from the frontend portion of multiple vehicles, vehicle use data may be received from multiple vehicles including a specific one of the vehicles to which notifications may be sent, which may be called a first vehicle. The use data may be provided from, for example, multiple vehicle sensors. In this way, use data is collected for multiple vehicles and also for each specific vehicle of the multiple vehicles to enable customized or individualized maintenance schedules and notifications to be provided.

In step 88, an adjusted maintenance schedule is determined for the first vehicle based at least in part on the vehicle use data for the first vehicle, and in step 90, a notification is provided from the backend portion to the first vehicle in accordance with the adjusted maintenance schedule. The notification may be provided based on a priority determined for the component or system or the repair or maintenance service needed. Things critical for vehicle operation or safety may be given a high priority while items not requiring immediate attention may be given a lower priority. In this way, the system effectively communicates with users and provides recommendations and notifications that are tailored to the vehicle and that take into account user preferences.

In step 92, the adjusted maintenance schedule, and/or information related thereto, is made available to one or more entities, such as at least one service center, component manufacturers and the vehicle manufacturer. These entities may use the information provided to troubleshoot and fix problems, plan for part production and plan for vehicle servicing based on data relevant to each entity. For example, the information related to the adjusted maintenance schedule can include information regarding a part and a service that will be needed by the first vehicle within a threshold amount of time. This information can be used to ensure that there is a sufficient supply of parts and labor to accomplish the needed repairs, for each vehicle within the fleet of vehicles. Further, the time period can be chosen as a function of the total cost of the repair as noted below.

The various method steps and models may be carried out in a different order, and steps may be repeated one or more times, at different times, during performance of the method. For example, the use of algorithms and other analyses can be done at different times for the same or different data sets and types of information, as desired.

As noted herein, the methods and systems may use predictive algorithms and analytics to determine the adjusted maintenance schedule, where the schedule is based at least in part on a wide range of data. The data may include, for example, a base maintenance schedule, vehicle diagnostic codes generated during the use of a specific vehicle as well as for similar vehicles, dynamic vehicle use data from one or more vehicle sensors and collected over time as the vehicle is used, and various sources and types of external data. The adjusted, customized maintenance schedules can, among other things, reduce maintenance costs, improve vehicle performance, reduce vehicle downtime, improve vehicle safety and improve the timing and completion of maintenance services.

In use, a combination of a digital twin or virtual vehicle concept and AI-based data and system monitoring of the current state of components (software or hardware including mechanical parts in the actual vehicle) can be used to decide how particular components are performing. Through the proposed method the system can also determine if software needs attention due to recent vulnerabilities or updates that have been issued, to indicate to the user the impact of the respective components and provide recommendations.

The personalized vehicle maintenance recommendations or schedule(s) leverage vehicle data models and machine learning algorithms to provide continually updated maintenance suggestions to manufacturers, dealers, and owners. By analyzing vehicle usage patterns, driving behavior, personalized thresholds, and diagnostic data, the platform can generate personalized maintenance insights and recommendations, and apprise other entities of the same.

This creative approach uses artificial intelligence to transform our maintenance procedures, maximize equipment efficiency, and reduce downtime. The AI-based predictive maintenance system analyzes equipment data, makes preventive maintenance recommendations, and forecasts possible breakdowns using sophisticated machine learning algorithms. Through predictive analytics, real-time monitoring, and historical data, the system can detect maintenance needs before they result in expensive malfunctions or disruptions. Also, the system can recommend repairs in an optimal window to provide a lower total repair cost. This is shown in the graph of FIG. 6, in which line 94 shows an actual cost of a repair, line 96 shows a prevention cost, which increases the earlier the repair is made and line 98 shows a total cost which is the combined actual cost and prevention cost. The graph includes three areas that denote three maintenance phases including: 1) “Reactive Maintenance” which shows the costs for repairs made when needed, e.g., after a component has failed; 2) “Preventative Maintenance” which is done very early, before a component has failed, and when a component being repaired or replaced still has useful life and thus value (so the earlier the repair, the higher the cost as the unused useful life of a part is greater); and 3) “Predictive Maintenance” which is between the other two maintenance phases and is generated by the systems and models described herein to avoid component failures and harm that may be caused to other vehicle components by a poorly performing or malfunction component, and to provide more accurate repair or maintenance schedules. For example, waiting too long to replace brake pads when they are really worn, can cause damage to brake rotors and thus, require more repairs and higher cost. The need to replace brake pads before they reach this stage can be adjusted based on individual vehicle use and/or similar vehicle use by many vehicles in a fleet or pool of vehicles. The total cost denoted by line 98 is lowest in the predictive maintenance phase which shows that more accurate maintenance schedules can reduce overall cost, decrease vehicle downtime and improve owner satisfaction.

The system can assess the behavior of components and their lifespan using a threshold-driven method. For example, if a sensor is permitted to run for a limit of 1,000 iterations, an alert will be sent when its use reaches a threshold that is lower than the limit, for example 950 iterations. This lower threshold provides some lead time to allow the procurement team to schedule the procurement and replacement of the part. This will assist procurement teams in better planning their parts inventory, to ensure sufficient inventory is maintained but not too much. The threshold (i.e. the maintenance schedule) may be adjusted based on use data from a particular vehicle as well as for multiple vehicles in a fleet or pool of vehicles, for example, vehicles including the same part for which the threshold is set.

The system may assign priority ratings or levels to notifications based on the criticality of the component(s). For example, safety related issues, such as those relating to brakes, tires, airbags or the like, can be given a high priority rating or level and notifications may be provided to the user sooner than for lower priority rating or level issues. Significant mechanical components, the failure of which prevents the vehicle from being driven, like powertrain or drivetrain components, can be given a high priority if problems are determined to exist with such components, to avoid a driver being stranded or failing to reach a destination. In at least some implementations, the system may recommend that a first class of repairs, which may include safety related repairs, be done sooner (e.g. within a shorter time period) and closer to or within the preventative maintenance phase; a second class of repairs, which may include repairs to critical vehicle systems (e.g. the failure results in the vehicle being unable or unfit to drive) can be done sooner in the predictive maintenance phase but not as close to the preventative maintenance phase as the first class; and a third class of repairs, for components the failure of which is not a safety issue or critical to vehicle performance (like issues with interior lights, entertainment systems (e.g. radio) and the like), can be done later, and closer to the reactive maintenance phase.

That is, the time period in which the repair is recommended to be done is shorter for repairs that affect the vehicle safety or ability to operate after the repair becomes needed than for repairs not related to safety and for which the vehicle can continue to operate after the repair becomes needed. Similarly, the time period in which the repair is recommended to be done is shorter for components that affect other components, like brake pads as noted above, and transmission fluid changes, the failure to perform can harm the transmission. Notification timing and repair scheduling can follow these guidelines.

The system will monitor the vehicle use data and determine users'driving behavior and patterns, and can generate a report on the predictive maintenance schedule for one or more components. The adjusted or predictive maintenance schedule includes information about components or repairs that will be needed, and a time period for such service work. This information can be used to prepare service centers to staff certain parts as well as employees having certain skills to make the needed repairs. For example, if a transmission repair is needed soon, the service center of choice can be notified and the repair scheduled when a qualified technician is available at the service center.

The proposed systems will generate a predictive analytics dashboard allowing manufacturers and dealers to monitor parts usage and their lifecycle. This will help them plan the inventory and other necessary details to support data-driven decision-making. The system can recommend appropriate maintenance schedules based on expected failure probability, equipment criticality, and operating restrictions.

The system can recommend that a user install the latest software to ensure the models and systems are up to date. Software recommendations can also be made based on user-initiated searches using the IVI system or a remote device coupled to the IVI system. The vehicle manufacturer can then make recommendations for software or business with which an established relationship exists, if desired.

Further, the system can simulate with a digital twin the status of the physical vehicle and predict the future. For example, data like routing recommendations can be made based on vehicle status (e.g. energy level remaining in the vehicle), driving patterns of the user (e.g. avoid or prefer certain types of roads or areas (e.g. urban, city, etc)). This can also be used to ensure an improved system status of the vehicle, such as a pre-conditioning of the electrical storage system before arriving at a charging station with an electric vehicle.

The system can reduce vehicle downtime by predicting component failures and setting maintenance or repair schedules to achieve repair or replacement before failure. This can be done with increased accuracy to reduce the overall cost of repairs, including costs associated with repairs or replacements that are done too soon. Predictive maintenance can also recommend repair or replacement of a component to avoid a failing component having a negative impact on other components, to reduce the overall cost and downtime by limiting the negative impact. Further, some components may perform better than expected and the predictive maintenance schedule can be adjusted to recommend repair or replacement later, maximizing value and reducing cost.

1. A method for determining a vehicle maintenance schedule and communicating with a vehicle user, comprising:
determining at a backend portion a base maintenance schedule for one or more vehicle components of multiple vehicles based at least in part on background vehicle data;
receiving, from a frontend portion of multiple vehicles, vehicle use data for the multiple vehicles including a first vehicle;
determining an adjusted maintenance schedule for the first vehicle based at least in part on the vehicle use data for the first vehicle;
providing a notification from the backend portion to the first vehicle in accordance with the adjusted maintenance schedule; and
making information related to the adjusted maintenance schedule available to at least one vehicle service center, wherein determining an adjusted maintenance schedule is done as a function of a vehicle simulation performed at the backend portion, and wherein the vehicle simulation is performed based in part on vehicle use data from the first vehicle and from the multiple vehicles, where the vehicle use data from the first vehicle and the multiple vehicles is provided to the backend portion over time and the vehicle simulation is updated with the vehicle use data from the first vehicle and the multiple vehicles.

2. (canceled)

3. (canceled)

4. The method of claim 1 wherein the multiple vehicles each includes one or more components that are the same as a corresponding one or more components of the first vehicle.

5. The method of claim 1 wherein the background vehicle data includes one or more of a predetermined maintenance schedule provided by a vehicle manufacturer, a vehicle type and a vehicle age, and wherein the adjusted maintenance schedule is determined based at least in part on the predetermined maintenance schedule, the vehicle type and the vehicle age of the first vehicle, and based at least in part on the vehicle use data for the multiple vehicles other than the first vehicle.

6. The method of claim 1 wherein the adjusted maintenance schedule is based at least in part on diagnostic data from one or both of an onboard vehicle diagnostic system of the frontend portion and a remote vehicle diagnostic system of the backend portion.

7. The method of claim 1 wherein the vehicle simulation is conducted with a digital twin of the vehicle, and wherein the digital twin is updated with vehicle use data from the first vehicle and from the multiple vehicles, and the vehicle use data includes dynamic vehicle data from the first vehicle and from the multiple vehicles.

8. The method of claim 1 wherein the information related to the adjusted maintenance schedule includes information regarding a part and a service that will be needed by the first vehicle within a threshold amount of time.

9. The method of claim 1 wherein the adjusted maintenance schedule provides a priority level or rating for a service needed by the first vehicle, wherein the steps of providing the notification and making the information related to the adjusted maintenance schedule available to at least one vehicle service center are done within a time period established based at least in part on the priority level or rating.

10. The method of claim 9 wherein the time period is shorter for repairs that affect: a) the vehicle safety, or b) the ability to operate the vehicle after the repair becomes needed, than for c) repairs not related to safety and for which the vehicle can continue to operate after the repair becomes needed.

11. A system used to determine a vehicle maintenance schedule and communicate with a vehicle user, comprising:
one or more vehicle sensors;
a control system that includes a data storage unit and an electronic control unit, the control system being in communication with the one or more vehicle sensors;
a communications unit that is communicated with the control system and that has a receiver by which information is received at a network vehicle and a transmitter by which information is transmitted from the network vehicle; and
a backend portion of a cloud-based system, wherein the backend portion includes a processor and memory with programming to:
determine at a backend portion a base maintenance schedule for one or more vehicle components of multiple vehicles based at least in part on background vehicle data;
receive, from a frontend portion of multiple vehicles, vehicle use data for the multiple vehicles including a first vehicle;
determine an adjusted maintenance schedule for the first vehicle based at least in part on the vehicle use data for the first vehicle and the vehicle use data for the multiple vehicles, where each of the multiple vehicles includes one or more components that are the same as a corresponding one or more components of the first vehicle, and wherein the adjusted maintenance schedules relates to the one or more components;
provide a notification from the backend portion to the first vehicle in accordance with the adjusted maintenance schedule; and
make information regarding the adjusted maintenance schedule available to at least one service center.

12. The system of claim 11 wherein the vehicle use data includes data from one or more vehicle sensors.

13. The system of claim 11 wherein the background vehicle data includes a predetermined maintenance schedule provided by a vehicle manufacturer.

14. The system of claim 11 wherein the background vehicle data includes one or more of a vehicle type and a vehicle age, and wherein the adjusted maintenance schedule is determined based at least in part on the vehicle type of the first vehicle and the vehicle age of the first vehicle, and based at least in part on the vehicle use data for the multiple vehicles other than the first vehicle.

15. The system of claim 11 wherein the adjusted maintenance schedule is based at least in part on diagnostic data from one or both of an onboard vehicle diagnostic system of the frontend portion and a remote vehicle diagnostic system of the backend portion.

16. The system of claim 15 wherein the frontend portion generates diagnostic codes during use of the vehicle, and wherein the adjusted maintenance schedule is based at least in part on the diagnostic codes.

17. The system of claim 11 wherein the backend portion includes programming that provides a digital twin of the first vehicle and wherein the adjusted maintenance schedule is based at least in part on predicted future use of the first vehicle that is performed with the digital twin.

18. The system of claim 17 wherein determining an adjusted maintenance schedule is done as a function of a vehicle simulation performed at the backend portion.

19. The system of claim 17 wherein the vehicle simulation is performed based in part on vehicle use data from the first vehicle provided to the backend portion over time.

20. The system of claim 19 wherein the vehicle simulation is performed based in part on vehicle use data from the multiple vehicles provided to the backend portion over time.

21. The method of claim 1 wherein the vehicle use data includes information about repairs made to the first vehicle and the multiple vehicles of the first vehicle and the multiple vehicles, and wherein the adjusted maintenance schedule is adjusted as a function of the information about repairs made to the first vehicle and the multiple vehicles.

22. The method of claim 1 wherein the vehicle use data includes external data received at the backend portion, the external data including one or both of data from service centers, and information about environmental conditions in which the vehicles have been and are being used.
